(19) United States
(12) Patent Application Publication
(10) Pub. No.: US 2024/0097199 A1
(43) Pub. Date: Mar. 21, 2024

(54) NON-AQUEOUS RECHARGEABLE BATTERY AND METHOD FOR MANUFACTURING NON-AQUEOUS RECHARGEABLE BATTERY

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventors: Naoki WAKAMATSU, Toyohashi-shi (JP); Hiroki NAKAFUJI, Toyohashi-shi (JP); Shoki TAKADA, Toyohashi-shi (JP); Shunya MARUYAMA, Toyohashi-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/369,626

(22) Filed: Sep. 18, 2023

(30) Foreign Application Priority Data
Sep. 21, 2022 (JP) 2022150237

(51) Int. Cl. H01M 10/0587; H01M 4/04; H01M 4/139

(52) U.S. Cl. CPC H01M 10/0587; H01M 4/0404; H01M 4/043; H01M 4/0471; H01M 4/139; H01M 2004/021

(57) ABSTRACT

A non-aqueous rechargeable battery includes an electrode body formed by rolling a stack of a positive electrode plate and a negative electrode plate with a separator arranged in between. At least one of the positive electrode plate and the negative electrode plate includes a substrate, a first mixture layer located on an outer side of the substrate, and a second mixture layer located on an inner side of the substrate. The second mixture layer includes an active material having a BET specific surface area that is greater than that of an active material included in the first mixture layer.

### BACKGROUND

### 1. Field

The following description relates to a non-aqueous rechargeable battery and a method for manufacturing a non-aqueous rechargeable battery.

### 2. Description of Related Art

Electric vehicles and hybrid vehicles are powered by a non-aqueous rechargeable battery. A lithium-ion rechargeable battery, which is an example of a non-aqueous rechargeable battery, includes an electrode body formed by rolling a stack of a positive electrode plate, a negative electrode plate, and a separator (for example, International Patent Publication No. 2011/074098).

As shown in FIG. 13, an electrode body 50 is a rolled body formed by rolling a stack in which a positive electrode plate 51 and a negative electrode plate 54 are arranged with separators 57 held in between. The electrode body 50 includes a curved portion 50A in which the layers of the electrode body 50 are curved. The positive electrode plate 51 includes a positive electrode substrate 52 and positive electrode mixture layers 53A and 53B applied to two surfaces of the positive electrode substrate 52. The negative electrode plate 54 includes a negative electrode substrate 55 and negative electrode mixture layers 56A and 56B applied to two surfaces of the negative electrode substrate 55.

### SUMMARY

As shown in FIG. 14, at the curved portion 50A, the negative electrode mixture layer 56B of the negative electrode plate 54 located on an inner side of the negative electrode plate 54 will have a density that is greater than that of the negative electrode mixture layer 56A of the negative electrode plate 54 located an outer side of the negative electrode plate 54. In this case, it is more difficult for a non-aqueous electrolyte to permeate between the particles of the negative electrode active material 56C in the negative electrode mixture layer 56B than in the negative electrode mixture layer 56A. This may result in the negative electrode mixture layer 56B having a greater resistance than the negative electrode mixture layer 56A. In such a case, the lithium deposition resistance of the negative electrode mixture layer 56B may become lower than that of the negative electrode mixture layer 56A, in which case, the negative electrode mixture layer 56B will be more prone to lithium deposition. Such a problem with respect to the resistance difference, resulting from the density difference between the outer negative electrode mixture layer 56A and the inner negative electrode mixture layer 56B may also occur between the positive electrode mixture layer 53A located on an outer side of the positive electrode substrate 52 and the positive electrode mixture layer 53B located on an inner side of the positive electrode substrate 52.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a non-aqueous rechargeable battery includes an electrode body formed by rolling a stack of a positive electrode plate and a negative electrode plate with a separator arranged in between. At least one of the positive electrode plate and the negative electrode plate includes a substrate, a first mixture layer located on an outer side of the substrate, and a second mixture layer located on an inner side of the substrate. The second mixture layer includes an active material having a BET specific surface area that is greater than that of an active material included in the first mixture layer.

In the above non-aqueous rechargeable battery, the electrode body may include a curved portion in which layers of the electrode body are curved. The second mixture layer may have a density at the curved portion that is greater than that of the first mixture layer at the curved portion.

In another general aspect, a method for manufacturing a non-aqueous rechargeable battery includes manufacturing a positive electrode plate, manufacturing a negative electrode plate, and manufacturing an electrode body by rolling a stack of the positive electrode plate and the negative electrode plate with a separator arranged in between. At least one of the manufacturing the positive electrode plate and the manufacturing the negative electrode plate includes forming a first mixture layer on a first surface of a substrate, and forming a second mixture layer on a second surface of the substrate opposite to the first surface. The forming the second mixture layer on the second surface is performed such that the second mixture layer includes an active material having a BET specific surface area that is greater than that of an active material included in the first mixture layer. The manufacturing the electrode body includes rolling the substrate such that the first mixture layer is located on an outer side of the substrate and the second mixture layer is located on an inner side of the substrate.

In the above method, the forming the first mixture layer may include applying a first mixture paste to the first surface, and drying the first mixture paste. The forming the second mixture layer may include applying a second mixture paste to the second surface, and drying the second mixture paste. The second mixture paste may be dried at a speed that is lower than that of the first mixture paste.

In the above method, the forming the second mixture layer may be performed after the forming the first mixture layer.

In the above method, an active material used as a raw material of the second mixture layer may have a BET specific surface area that is greater than that of an active material used as a raw material of the first mixture layer.

In the above method, the forming the first mixture layer may include dry-kneading a first mixture paste including a raw material of the first mixture layer, and diluting the dry-kneaded first mixture paste. The forming the second mixture layer may include dry-kneading a second mixture paste including a raw material of the second mixture layer, and diluting the dry-kneaded second mixture paste. The second mixture paste that is dry-kneaded may have a solid content ratio that is lower than that of the first mixture paste that is dry-kneaded.

In the above method, the forming the first mixture layer may include pressing the first mixture layer to adjust a thickness of the first mixture layer. The forming the second mixture layer may include pressing the second mixture layer to adjust a thickness of the second mixture layer. A pressed amount of the second mixture layer may be greater than that of the first mixture layer.

In the above method, the forming the first mixture layer may further include applying a first mixture paste including a raw material of the first mixture layer to the first surface, and drying the first mixture paste. The forming the second mixture layer may further include applying a second mixture paste including a raw material of the second mixture layer to the second surface, and drying the second mixture paste. The applying a second mixture paste may be performed such that the second mixture paste has a weight per unit area that is greater than that of the first mixture paste.

In the above method, the forming the first mixture layer may further include dry-kneading a first mixture paste including a raw material of the first mixture layer, diluting the dry-kneaded first mixture paste, applying the diluted first mixture paste to the first surface, and drying the first mixture paste. The forming the second mixture layer may further include dry-kneading a second mixture paste including a raw material of the second mixture layer, diluting the dry-kneaded second mixture paste, applying the diluted second mixture paste to the second surface, and drying the second mixture paste. The diluting the dry-kneaded second mixture paste may be performed such that the diluted second mixture paste has a solid content ratio that is greater than that of the diluted first mixture paste.

In the above method, an active material used as a raw material of the second mixture layer may have a tapped density that is less than that of an active material used as a raw material of the first mixture layer.

Other features and aspects will be apparent from the following detailed description, the drawings, and the claims.

### BRIEF DESCRIPTION OF THE DRAWINGS

FIG. 1 is a perspective view of a lithium-ion rechargeable battery.

FIG. 2 is a perspective view of an electrode body in an unrolled state.

FIG. 3 is a cross-sectional view taken along line of FIG. 2.

FIG. 4 is an enlarged cross-sectional view showing a curved portion of the electrode body.

FIG. 5 is an enlarged cross-sectional view showing a negative electrode plate in the curved portion of the electrode body.

FIG. 6 is a graph schematically showing the relationship between a density of a negative electrode mixture layer, having a predetermined BET specific surface area, and a critical current value at which lithium deposition occurs.

FIG. 7 is a flowchart illustrating a manufacturing process of a negative electrode mixture paste.

FIG. 8 is a flowchart illustrating a manufacturing process of the negative electrode plate.

FIG. 9 is a flowchart illustrating an assembly process of the lithium-ion rechargeable battery.

FIG. 10 is a graph showing changes in a BET specific surface area of the negative electrode plate during the manufacturing process of the lithium-ion rechargeable battery.

FIG. 11 is a cross-sectional view schematically showing a negative electrode active material and a negative electrode binder when a drying condition is changed between a first negative electrode mixture layer and a second negative electrode mixture layer.

FIG. 12 is a cross-sectional view schematically showing the negative electrode plate shown in FIG. 11 in a rolled state.

FIG. 13 is an enlarged cross-sectional view showing a curved portion of an electrode body in a lithium-ion rechargeable battery, known in the art.

FIG. 14 is an enlarged cross-sectional view showing a negative electrode plate of the electrode body shown in FIG. 13.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

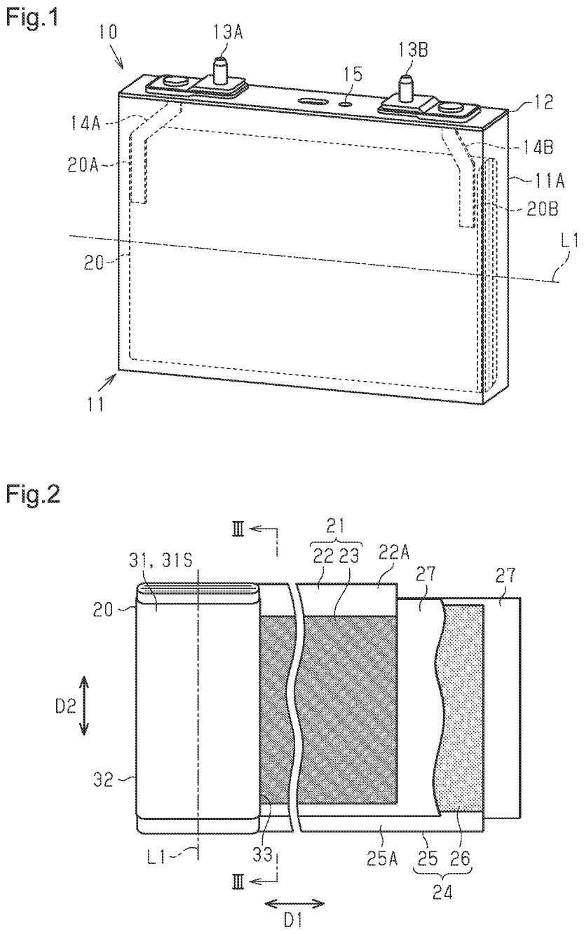

An embodiment of the present disclosure will now be described with reference to FIGS. 1 to 12.

Lithium-Ion Rechargeable Battery

As shown in FIG. 1, a lithium-ion rechargeable battery 10, which is an example of a non-aqueous rechargeable battery, includes a case 11 and an electrode body 20. The case 11 includes an accommodation portion 11A and a lid 12. The accommodation portion 11A is box-shaped and has an open upper end. The accommodation portion 11A accommodates the electrode body 20 and a non-aqueous electrolyte. The lid 12 closes the opening of the accommodation portion 11A. The case 11 forms a sealed box-shaped battery container by attaching the lid 12 to the accommodation portion 11A. The case 11 is formed from a metal such as aluminum or an aluminum alloy.

An external terminal 13A of the positive electrode and an external terminal 13B of the negative electrode are arranged on the lid 12. The external terminals 13A and 13B are used to charge and discharge electric power. A positive electrode current collector portion 20A, which is the positive end of the electrode body 20, is electrically connected by a positive electrode current collector member 14A to the positive electrode external terminal 13A. A negative electrode current collector portion 20B, which is the negative end of the electrode body 20, is electrically connected by a negative electrode current collector member 14B to the negative electrode external terminal 13B. Further, the lid 12 includes an inlet 15 for injection of the non-aqueous electrolyte. The external terminals 13A and 13B do not have to be shaped as shown in FIG. 1 and may have any shape.

Electrode Body

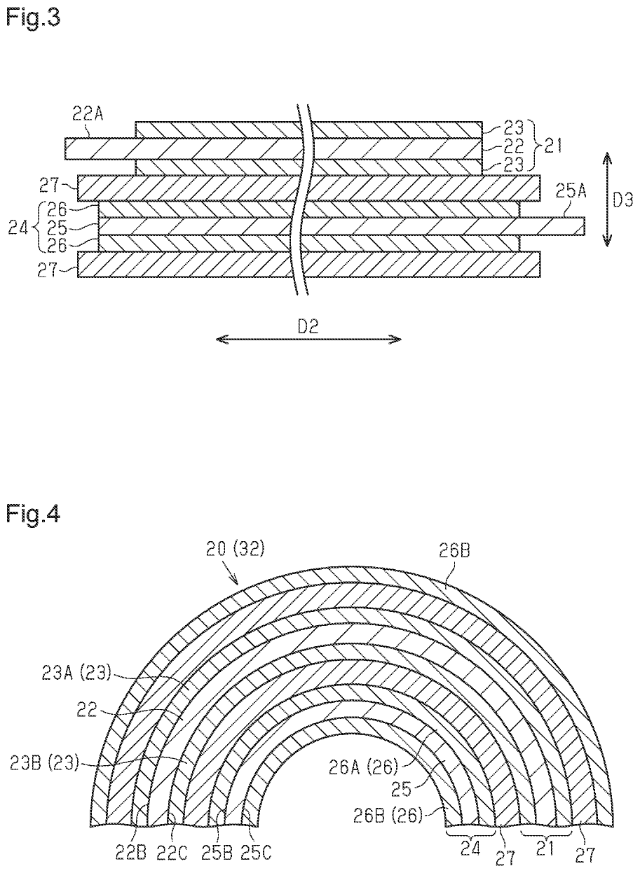

As shown in FIG. 2, the electrode body 20 is a flat rolled body formed by rolling a stack of strips of a positive electrode plate 21, a negative electrode plate 24, and separators 27. The positive electrode plate 21, the negative electrode plate 24, and the separators 27 are stacked so that their long sides are parallel to a longitudinal direction DE The positive electrode plate 21, the separator 27, the negative electrode plate 24, and the separator 27 are arranged in this order in a stacking direction D3 (refer to FIG. 3) to form an unrolled stack. The electrode body 20 is structured by rolling the stack of the positive electrode plate 21 and the negative electrode plate 24 with the separators 27 held in between about a rolling axis L1 that extends in a widthwise direction D2 of the strips.

The electrode body 20 includes a flat portion 31, an upper curved portion 32, and a lower curved portion 33. The flat portion 31 includes two flat surfaces 31S facing opposite directions. The upper curved portion 32 is located above the flat portion 31. The upper curved portion 32 is bulged upwardly from the upper end of the flat portion 31. The lower curved portion 33 is located below the flat portion 31. The lower curved portion 33 is bulged downwardly from the lower end of the flat portion 31. The electrode body 20 is accommodated in the case 11 in a state in which the rolling axis L1 extends parallel to the bottom surface of the accommodation portion 11A so that the lower curved portion 33 is located toward the bottom surface of the accommodation portion 11A and the upper curved portion 32 is located toward the lid 12. Each of the upper curved portion 32 and the lower curved portion 33 is an example of a curved portion of the electrode body 20.

Positive Electrode Plate

As shown in FIG. 3, the positive electrode plate 21 includes a positive electrode substrate 22 and a positive electrode mixture layer 23. The positive electrode substrate 22 is a strip of a foil. The positive electrode mixture layer 23 is applied to each of two opposite surfaces of the positive electrode substrate 22. One end of the positive electrode substrate 22 in the widthwise direction D2 includes a positive electrode uncoated portion 22A where the positive electrode mixture layer 23 is not formed and the positive electrode substrate 22 is exposed.

The positive electrode substrate 22 is a foil of a metal such as aluminum or an alloy having aluminum as a main component. In the roll, opposing parts in the positive electrode uncoated portion 22A of the positive electrode substrate 22 are press-bonded together to form the positive electrode current collector portion 20A.

The positive electrode mixture layer 23 is formed by hardening a positive electrode mixture paste, which is in a liquid form. The positive electrode mixture paste includes a positive electrode active material, a positive electrode solvent, a positive electrode conductive material, and a positive electrode binder. The positive electrode mixture paste is dried and the positive electrode solvent is vaporized to form the positive electrode mixture layer 23. Thus, the positive electrode mixture layer 23 includes the positive electrode active material, the positive electrode conductive material, and the positive electrode binder.

The positive electrode active material is a lithium-containing composite metal oxide that allows for the storage and release of lithium ions, which serve as the charge carrier of the lithium-ion rechargeable battery 10. A lithium-containing composite metal oxide is an oxide containing lithium and a metal element other than lithium. The metal element other than lithium is, for example, one selected from a group consisting of nickel, cobalt, manganese, vanadium, magnesium, molybdenum, niobium, titanium, tungsten, aluminum, and iron contained as iron phosphate in the lithium-containing composite metal oxide.

The lithium-containing composite metal oxide may be, for example, lithium cobalt oxide (LiCoO₂), lithium nickel oxide (LiNiO₂), or lithium manganese oxide (LiMn₂O₄). Further, the lithium-containing composite metal oxide may be, for example, a three-element lithium-containing composite metal oxide (NCM) that contains nickel, cobalt, and manganese, that is, lithium nickel manganese cobalt oxide (LiNiCoMnO₂). Further, the lithium-containing composite metal oxide may be, for example, lithium iron phosphate (LiFePO₄).

The positive electrode solvent is an N-methyl-2-pyrrolidone (NMP) solution, which is an example of an organic solvent. The positive electrode conductive material is, for example, carbon black such as acetylene black (AB) or ketjen black, carbon fibers such as carbon nanotubes (CNT) or carbon nanofibers, or graphite. The positive electrode binder is an example of a resin component included in the positive electrode mixture paste. The positive electrode binder is, for example, one selected from a group consisting of polyvinylidene fluoride (PVDF), polyvinyl alcohol (PVA), and styrene-butadiene rubber (SBR). The mass ratio of the positive electrode binder is, for example, in a range of 0.1 mass % to 20 mass % with respect to the mass of the positive electrode mixture layer 23.

The positive electrode plate 21 may include an insulation layer between the positive electrode uncoated portion 22A and the positive electrode mixture layer 23. The insulation layer includes an insulative inorganic component and a resin component that functions as a binder. The inorganic material is at least one selected from a group consisting of powdered boehmite, titania, and alumina. The resin component is at least one selected from a group consisting of PVDF, PVA, and acrylic.

Negative Electrode Plate

The negative electrode plate 24 includes a negative electrode substrate 25 and a negative electrode mixture layer 26. The negative electrode substrate 25 is a strip of a foil. The negative electrode mixture layer 26 is applied to each of two opposite surfaces of the negative electrode substrate 25. One end of the negative electrode substrate 25 in the widthwise direction D2 at the side opposite the positive electrode uncoated portion 22A includes a negative electrode uncoated portion 25A where the negative electrode mixture layer 26 is not formed and the negative electrode substrate 25 is exposed.

The negative electrode substrate 25 is a foil of a metal such as copper or an alloy having copper as a main component. In the roll, opposing parts in the negative electrode uncoated portion 25A are pressed-bonded together to form the negative electrode current collector portion 20B.

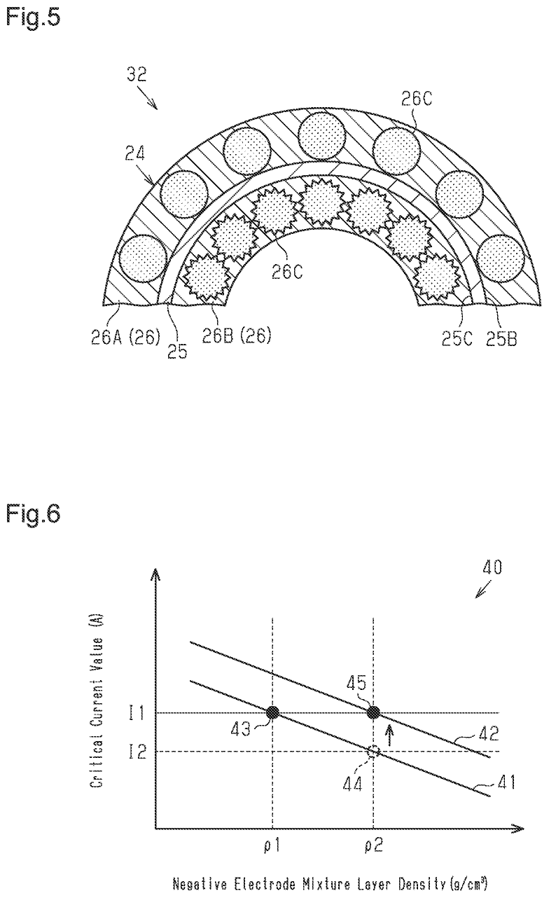

The negative electrode mixture layer 26 is formed by hardening a negative electrode mixture paste, which is in a liquid form. The negative electrode mixture paste includes a negative electrode active material 26C (refer to FIG. 5), a negative electrode solvent, a negative electrode conductive material, a negative electrode viscosity increasing agent, and a negative electrode binder 26D (refer to FIG. 11). The negative electrode mixture paste is dried and the negative electrode solvent is vaporized to form the negative electrode mixture layer 26. Thus, the negative electrode mixture layer 26 includes the negative electrode active material 26C, the negative electrode conductive material, the negative electrode viscosity increasing agent, and the negative electrode binder 26D.

The negative electrode active material 26C allows for the storage and release of lithium ions. The negative electrode active material 26C is, for example, a carbon material such as graphite, hard carbon, soft carbon, or carbon nanotubes. The negative electrode active material 26C may be composite particles in which graphite particles are coated with an amorphous carbon layer.

An example of the negative electrode solvent is water. The negative electrode conductive material may be the same material as the positive electrode conductive material. An example of the negative electrode viscosity increasing agent may be carboxymethyl cellulose (CMC). The mass ratio of the negative electrode viscosity increasing agent is, for example, in a range of 0.1 mass % to 20 mass % with respect to the mass of negative electrode mixture layer 26. The negative electrode binder 26D is at least one selected from a group consisting of PVDF, PVA, and SBR. The mass ratio of the negative electrode binder 26D is, for example, in a range of 0.1 mass % to 20 mass % with respect to the mass of negative electrode mixture layer 26.

Separator

The separators 27 prevent contact between the positive electrode plate 21 and the negative electrode plate 24 in addition to holding the non-aqueous electrolyte between the positive electrode plate 21 and the negative electrode plate 24. Immersion of the electrode body 20 in the non-aqueous electrolyte results in the non-aqueous electrolyte permeating each separator 27 from the ends toward the center.

Each separator 27 is a nonwoven fabric of polypropylene or the like. The separator 27 may be, for example, a porous polymer film, such as a porous polyethylene film, a porous polyolefin film, or a porous polyvinyl chloride film, an ion conductive polymer electrolyte film, or the like.

Non-Aqueous Electrolyte

The non-aqueous electrolyte is a composition containing a supporting electrolyte in a non-aqueous solvent. The non-aqueous solvent is one or two or more selected from, for example, a group consisting of propylene carbonate, ethylene carbonate, diethyl carbonate, dimethyl carbonate, and ethyl methyl carbonate. The supporting electrolyte is a lithium compound (lithium salt) of one or two or more selected from, for example, a group consisting of LiPF₆, LiBF₄, LiClO₄, LiAsF₆, LiCF₃SO₃, LiC₄F₉SO₃, LiN(CF₃SO₂)₂, LiC(CF₃SO₂)₃, LiI, and the like.

In the present embodiment, ethylene carbonate is used as the non-aqueous solvent. Lithium bis(oxalate)borate (LiBOB), which is a lithium salt, is added to the non-aqueous electrolyte as an additive. For example, LiBOB is added to the non-aqueous electrolyte so that the concentration of LiBOB in the non-aqueous electrolyte is in a range of 0.001 mol/L to 0.1 mol/L.

Structure of Curved Portion

As shown in FIG. 4, the upper curved portion 32 of the electrode body 20 has a structure in which the layers of the electrode body 20 are curved. The structure of the lower curved portion 33 is reversed upside down from the structure of the upper curved portion 32.

The positive electrode substrate 22 includes a first surface 22B and a second surface 22C. The first surface 22B and the second surface 22C face opposite directions, and the positive electrode mixture layer 23 is arranged on each of the two surfaces. The first surface 22B faces an outer side with respect to a rolled direction of the electrode body 20. The second surface 22C faces an inner side with respect to the rolled direction of the electrode body 20. In other words, the positive electrode substrate 22 includes the second surface 22C facing the rolling axis L1 of the electrode body 20 and the first surface 22B located opposite to the second surface 22C.

The positive electrode mixture layer 23 arranged on the first surface 22B defines a first positive electrode mixture layer 23A. The positive electrode mixture layer 23 arranged on the second surface 22C defines a second positive electrode mixture layer 23B. In the following description, when the first positive electrode mixture layer 23A and the second positive electrode mixture layer 23B are not distinguished from each other, they will be simply referred to as the positive electrode mixture layer 23.

The negative electrode substrate 25 includes a first surface 25B and a second surface 25C. The first surface 25B and the second surface 25C are two surfaces facing opposite directions, and the negative electrode mixture layer 26 is arranged on each of the two surfaces. The first surface 25B faces an outer side with respect to the rolled direction in which the electrode body 20. The second surface 25C faces an inner side with respect to the rolled direction in which the electrode body 20. In other words, the negative electrode substrate 25 includes the second surface 25C facing the rolling axis L1 of the electrode body 20 and the first surface 25B located opposite to the second surface 25C.

The negative electrode mixture layer 26 arranged on the first surface 25B defines a first negative electrode mixture layer 26A. The negative electrode mixture layer 26 arranged on the second surface 25C defines a second negative electrode mixture layer 26B. In the following description, when the first negative electrode mixture layer 26A and the second negative electrode mixture layer 26B are not distinguished from each other, they will be simply referred to as the negative electrode mixture layer 26.

The first positive electrode mixture layer 23A is an example of a first mixture layer located on the outer side of the positive electrode substrate 22. The first negative electrode mixture layer 26A is an example of a first mixture layer located on the outer side of the negative electrode substrate 25. The second positive electrode mixture layer 23B is an example of a second mixture layer located on the inner side of the positive electrode substrate 22. The second negative electrode mixture layer 26B is an example of a second mixture layer located on the inner side of the negative electrode substrate 25.

As shown in FIG. 5, at the upper curved portion 32 of the electrode body 20, the second negative electrode mixture layer 26B is closer to the center of the curved shape than the first negative electrode mixture layer 26A. Thus, when the electrode body 20 is rolled, the second negative electrode mixture layer 26B is compressed more strongly than the first negative electrode mixture layer 26A, and thus the density of the second negative electrode mixture layer 26B becomes greater than that of the first negative electrode mixture layer 26A. Accordingly, it is more difficult for the non-aqueous electrolyte to penetrate into the second negative electrode mixture layer 26B than the first negative electrode mixture layer 26A. This increases the resistance of the second negative electrode mixture layer 26B and lowers the rate at which lithium ions are accepted during charging.

When the rate of accepting lithium ions becomes too low, the lithium ions released from the positive electrode mixture layer 23 may be deposited on the surface of the negative electrode mixture layer 26 as lithium metal. The deposition of lithium metal reduces the amount of lithium ions that contribute to charge-discharge reactions, which in turn, lowers the battery performance qualities.

The first negative electrode mixture layer 26A has a density, for example, in a range of 1.00 g/cm³ to 1.40 g/cm³. The second negative electrode mixture layer 26B has a density, for example, in a range of 1.01 g/cm³ to 1.43 g/cm³. The density difference between the first negative electrode mixture layer 26A and the second negative electrode mixture layer 26B is, for example, in a range of 0.01 g/cm³ to 0.03 g/cm³. The density of the second negative electrode mixture layer 26B is, for example, in a range of 1.01 to 1.02 times that of the first negative electrode mixture layer 26A.

The negative electrode active material 26C in the second negative electrode mixture layer 26B has a Brunauer-Emmett-Teller (BET) specific surface area that is greater than that of the negative electrode active material 26C in the first negative electrode mixture layer 26A. The BET specific surface area is a value measured by a BET method performed on a sample that is obtained by cutting out a part of the negative electrode mixture layer 26. An adsorption gas used in the measurement of the BET specific surface area is, for example, nitrogen gas. The BET specific surface area represents the effective specific surface area per unit weight. The term “effective specific surface area” refers to a specific surface area of the reactive surface on the negative electrode active material 26C that contributes to charge-discharge reactions. For example, the BET specific surface area excludes the area of the negative electrode active material 26C that does not contribute to charge-discharge reactions, such as portions covered with the negative electrode binder 26D.

The negative electrode active material 26C in the second negative electrode mixture layer 26B has a greater BET specific surface area than the first negative electrode mixture layer 26A. This decreases the resistance of the second negative electrode mixture layer 26B and increases the rate at which lithium ions are accepted during charging.

The BET specific surface area of the negative electrode active material 26C in the first negative electrode mixture layer 26A is, for example, in a range of 3.8 cm²/g to 4.2 cm²/g. The BET specific surface area of the negative electrode active material 26C in the second negative electrode mixture layer 26B is, for example, in a range of 4.3 cm²/g to 4.7 cm²/g. The difference in the BET specific surface area of the negative electrode active material 26C between the first negative electrode mixture layer 26A and the second negative electrode mixture layer 26B is, for example, in a range of 0.3 cm²/g to 0.7 cm²/g. The BET specific surface area of the negative electrode active material 26C in the second negative electrode mixture layer 26B is, for example, in a range of 1.02 to 1.24 times that of the negative electrode active material 26C in the first negative electrode mixture layer 26A.

As described above, from the aspect of the density difference at the upper curved portion 32, the second negative electrode mixture layer 26B is likely to have a greater resistance than the first negative electrode mixture layer 26A because the second negative electrode mixture layer 26B holds a smaller amount of the non-aqueous electrolyte. On the other hand, from the aspect of the BET specific surface area at the upper curved portion 32, the second negative electrode mixture layer 26B is likely to have a smaller resistance than the first negative electrode mixture layer 26A because the second negative electrode mixture layer 26B has a greater BET specific surface area of the negative electrode active material 26C. In this manner, the resistance difference between the first negative electrode mixture layer 26A and the second negative electrode mixture layer 26B in the upper curved portion 32 is reduced by setting the BET specific surface area of the negative electrode active material 26C to be greater in the second negative electrode mixture layer 26B than in the first negative electrode mixture layer 26A. Thus, the difference in the rate of accepting lithium ions is decreased between the first negative electrode mixture layer 26A and the second negative electrode mixture layer 26B. Consequently, the resistance against lithium deposition is uniformized in the upper curved portion 32. Also, in the same manner as the upper curved portion 32, the difference in the resistance and the difference in the rate of accepting lithium ions are reduced between the first negative electrode mixture layer 26A and the second negative electrode mixture layer 26B at the lower curved portion 33.

In the same manner as the first negative electrode mixture layer 26A and the second negative electrode mixture layer 26B, the positive electrode active material in the second positive electrode mixture layer 23B may have a BET specific surface area that is greater than that of the positive electrode active material in the first positive electrode mixture layer 23A. The second positive electrode mixture layer 23B in the upper curved portion 32 has a higher density than the first positive electrode mixture layer 23A and thus the non-aqueous electrolyte is less likely to penetrate into the second positive electrode mixture layer 23B. This increases the resistance of the second positive electrode mixture layer 23B to be greater than that of the first positive electrode mixture layer 23A and lowers the rate at which lithium ions are released during charging.

In this manner, the resistance difference between the first positive electrode mixture layer 23A and the second positive electrode mixture layer 23B in the upper curved portion 32 can be reduced by setting the BET specific surface area of the positive electrode active material to be greater in the second positive electrode mixture layer 23B than in the first positive electrode mixture layer 23A. Thus, the difference in the rate of releasing lithium ions is decreased between the first positive electrode mixture layer 23A and the second positive electrode mixture layer 23B in the upper curved portion 32. Consequently, the lithium deposition resistance is further uniformized between the second negative electrode mixture layer 26B, facing the first positive electrode mixture layer 23A, and the lithium deposition resistance in the first negative electrode mixture layer 26A, facing the second positive electrode mixture layer 23B.

In order to change the BET specific surface area of the negative electrode active material 26C, the first negative electrode mixture layer 26A and the second negative electrode mixture layer 26B may have different raw materials and/or different manufacturing conditions. In the same manner, in order to change the BET specific surface area of the positive electrode active material, the first positive electrode mixture layer 23A and the second positive electrode mixture layer 23B may have different raw materials and/or different manufacturing conditions.

Lithium Deposition Resistance

The relationship between the density of the negative electrode mixture layer 26, the BET specific surface area of the negative electrode active material 26C, and the lithium deposition resistance will now be described with reference to FIG. 6.

In graph 40 shown in FIG. 6, the horizontal axis indicates the density of the negative electrode mixture layer 26, and the vertical axis indicates the critical current value at which lithium metal is deposited during charging. A higher critical current value means a higher lithium deposition resistance, and a lower critical current value means a lower lithium deposition resistance. Straight line 41 shown in graph 40 represents the relationship of the critical current value and the density of the negative electrode mixture layer 26 when the BET specific surface area of the negative electrode active material 26C is a first specific surface area. Straight line 42 shown in graph 40 represents the relationship of the critical current value and the density of the negative electrode mixture layer 26 when the BET specific surface area of the negative electrode active material 26C is a second specific surface area that is greater than the first specific surface area.

Straight lines 41 and 42 indicate that, with the same BET specific surface area of the negative electrode active material 26C, the critical current value, or the lithium deposition resistance, decreases as the density of the negative electrode mixture layer 26 increases. Further, with the same density of the negative electrode mixture layer 26, the critical current value, or the lithium deposition resistance, decreases as the BET specific surface area of the negative electrode active material 26C decreases.

In an example, at the upper curved portion 32, the first negative electrode mixture layer 26A located on the outer side has a first density ρ1, and the second negative electrode mixture layer 26B located on the inner side has a second density ρ2 (ρ2>ρ1). If the BET specific surface area of the negative electrode active material 26C in the first negative electrode mixture layer 26A is the first specific surface area, the critical current value of the first negative electrode mixture layer 26A is a first current value I1. Point 43 on straight line 41 shown in graph 40 indicates the critical current value when the density of the negative electrode mixture layer 26 is the first density ρ1.

In this case, when the BET specific surface area of the negative electrode active material 26C in the second negative electrode mixture layer 26B is the first specific surface area, which is the same as the first negative electrode mixture layer 26A, the critical current value of the second negative electrode mixture layer 26B is a second current value I2 that is less than the first current value I1. That is, the lithium deposition resistance in the second negative electrode mixture layer 26B is lower than that of the first negative electrode mixture layer 26A. Point 44 indicated by the broken line on straight line 41 shown in graph 40 indicates the critical current value when the density of the negative electrode mixture layer 26 is the second density ρ2.

The critical current value of the second negative electrode mixture layer 26B becomes closer to that of the first negative electrode mixture layer 26A by increasing the BET specific surface area of the negative electrode active material 26C in the second negative electrode mixture layer 26B to be greater than the first specific surface area. Thus, when the density of the second negative electrode mixture layer 26B is the second density ρ2, the BET specific surface area of the negative electrode active material 26C in the second negative electrode mixture layer 26B is determined so that the critical current value of the second negative electrode mixture layer 26B becomes closer to the first current value I1.

Further, FIG. 6 illustrates an example in which the second negative electrode mixture layer 26B has the second density ρ2, the BET specific surface area of the negative electrode active material 26C in the second negative electrode mixture layer 26B is the second specific surface area, and the critical current value is the first current value I1. Point 45 on straight line 42 shown in graph 40 indicates the critical current value when the density of the negative electrode mixture layer 26 is the second density ρ2.

In a reference example, in graph 40, when the first density ρ1 is 1.174 g/cm³, the second density ρ2 is 1.189 g/cm³, and the first specific surface area is 4.00 cm²/g, the difference between the first current value I1 and the second current value I2 is approximately 11.3 A. In this case, the targeted value of the second specific surface area for reducing the difference between the first current value I1 and the second current value I2 is 4.33 cm²/g.

Method for Manufacturing Lithium-Ion Rechargeable Battery

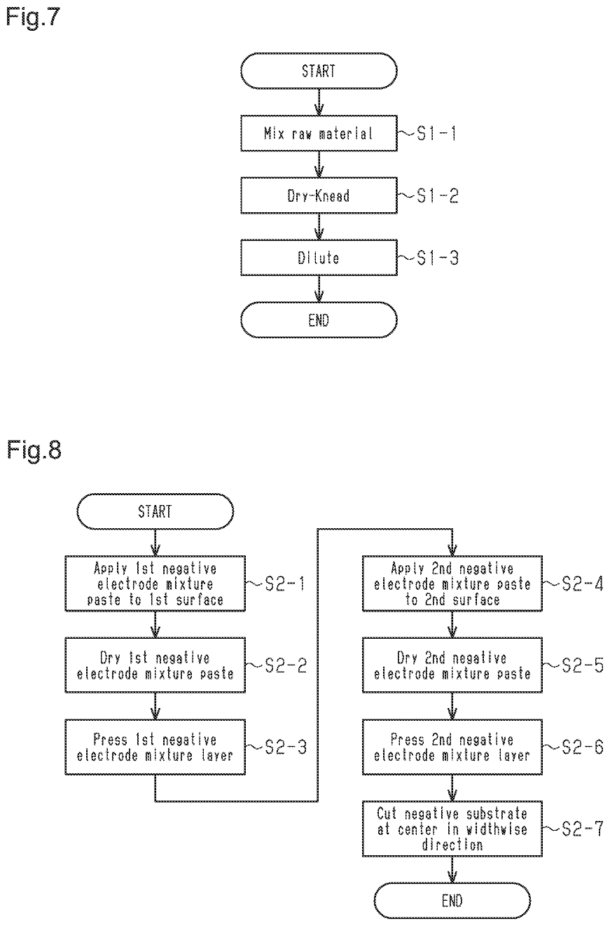

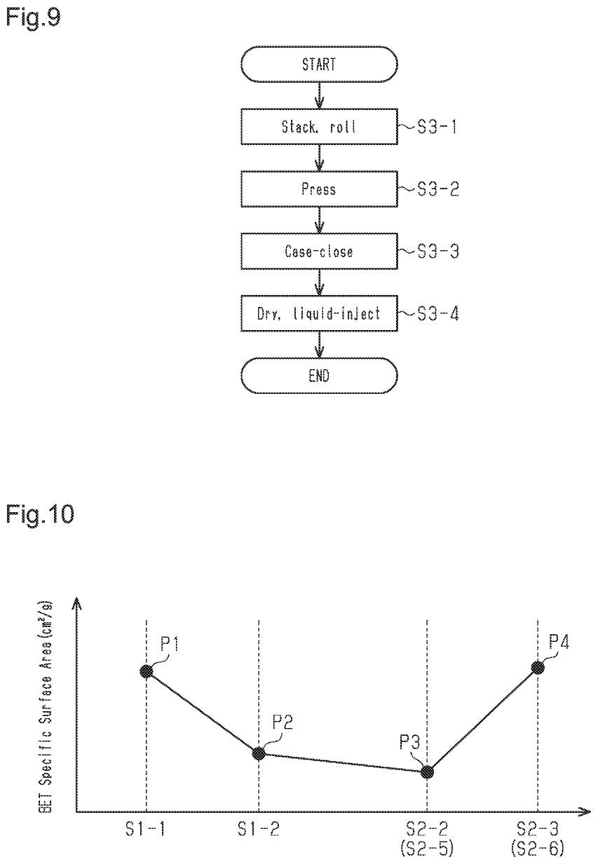

A method for manufacturing the lithium-ion rechargeable battery 10 includes steps S1-1 to S1-3 shown in FIG. 7, steps S2-1 to S2-7 shown in FIG. 8, and steps S3-1 to S3-4 shown in FIG. 9.

Steps S1-1 to S1-3 shown in FIG. 7 are part of a process for manufacturing the negative electrode plate 24, and are steps of manufacturing a negative electrode mixture paste. A process for manufacturing the positive electrode plate 21 includes steps of manufacturing a positive electrode mixture paste. The basic flow of the steps of manufacturing a positive electrode mixture paste is the same as that of manufacturing a negative electrode mixture paste except for raw materials, manufacturing conditions, and the like. Thus, such steps will not be described in detail.

In step S1-1 of manufacturing a negative electrode mixture paste, raw materials of the negative electrode mixture layer 26 are mixed. In step S1-2, the raw materials are blended and dry-kneaded in a state in which the solid content ratio of the raw materials is higher than that of the manufactured negative electrode mixture paste. In step S1-3, the dry-kneaded negative electrode mixture paste is diluted with the negative electrode solvent to adjust the solid content ratio of the negative electrode mixture paste. The negative electrode mixture paste is manufactured through the above steps.

When the raw materials or the manufacturing conditions differ between the first negative electrode mixture paste, containing the raw materials of the first negative electrode mixture layer 26A, and the second negative electrode mixture paste, containing the raw materials of the second negative electrode mixture layer 26B, the first negative electrode mixture paste and the second negative electrode mixture paste are separately manufactured. Also, when the raw materials or the manufacturing conditions differ between the first positive electrode mixture paste, containing the raw materials of the first positive electrode mixture layer 23A, and the second positive electrode mixture paste, containing the raw materials of the second positive electrode mixture layer 23B, the first positive electrode mixture paste and the second positive electrode mixture paste are separately manufactured. Each of the first positive electrode mixture paste and the first negative electrode mixture paste is an example of a first mixture paste. Each of the second positive electrode mixture paste and the second negative electrode mixture paste is an example of a second mixture paste.

Steps S2-1 to S2-7 shown in FIG. 8 are part of the process for manufacturing the negative electrode plate 24, and are steps of forming the negative electrode mixture layer 26 on the negative electrode substrate 25 using the negative electrode mixture paste. The process for manufacturing the positive electrode plate 21 includes steps of forming the positive electrode mixture layer 23 on the positive electrode substrate 22. The basic flow of the steps of forming the positive electrode mixture layer 23 on the positive electrode substrate 22 is the same as that of forming the negative electrode mixture layer 26 on the negative electrode substrate 25 except for raw materials, manufacturing conditions, and the like. Thus, such steps will not be described in detail.

In step S2-1 of forming the negative electrode mixture layer 26 on the negative electrode substrate 25, the first negative electrode mixture paste is applied to the first surface 25B of the negative electrode substrate 25 so that the negative electrode uncoated portion 25A is included at both ends in the widthwise direction D2. In step S2-2, the first negative electrode mixture paste is dried and the negative electrode solvent is vaporized to form the first negative electrode mixture layer 26A. In this case, for example, the first negative electrode mixture paste is dried by dry air blown on the first negative electrode mixture paste from the side opposite to the negative electrode substrate 25. In step S2-3, the first negative electrode mixture layer 26A is pressed by a press roll to adjust the thickness of the first negative electrode mixture layer 26A.

Subsequently, in step S2-4, the second negative electrode mixture paste is applied to the second surface 25C of the negative electrode substrate 25 so that the negative electrode uncoated portion 25A is included at both ends in the widthwise direction D2. In step S2-5, the second negative electrode mixture paste is dried and the negative electrode solvent is vaporized to form the second negative electrode mixture layer 26B. In this case, for example, the second negative electrode mixture paste is dried by dry air blown on the second negative electrode mixture paste from the side opposite to the negative electrode substrate 25. In step S2-6, the second negative electrode mixture layer 26B is pressed by a press roll to adjust the thickness of the second negative electrode mixture layer 26B. Finally, in step S2-7, the negative electrode substrate 25 is cut at the center in the widthwise direction D2. In this manner, two strips of the negative electrode plates 24 are manufactured at the same time through the above steps.

Steps S3-1 to S3-4 shown in FIG. 9 include steps of manufacturing the electrode body 20 using the positive electrode plates 21, the negative electrode plates 24, and the separators 27, and steps of accommodating the electrode body 20 inside the case 11. In step S3-1 of manufacturing the electrode body 20, the positive electrode plate 21, the negative electrode plate 24, and the separators 27 are stacked and rolled. Further, the roll is pressed and flattened. In this case, the positive electrode substrate 22 is rolled such that the first positive electrode mixture layer 23A is located on the outer side of the positive electrode substrate 22 and the second positive electrode mixture layer 23B is located on the inner side of the positive electrode substrate 22. Further, the negative electrode substrate 25 is rolled such that the first negative electrode mixture layer 26A is located on the outer side of the negative electrode substrate 25 and the second negative electrode mixture layer 26B is located on the inner side of the negative electrode substrate 25.

In step S3-2, the positive electrode uncoated portion 22A is press-bonded to form the positive electrode current collector portion 20A. Further, the negative electrode uncoated portion 25A is press-bonded to form the negative electrode current collector portion 20B. These procedures manufacture the electrode body 20.

Subsequently, in step S3-3, the electrode body 20 is sealed in the case 11. In this case, the positive electrode current collector portion 20A is connected by the positive electrode current collector member 14A to the positive electrode external terminal 13A. The negative electrode current collector portion 20B is connected by the negative electrode current collector member 14B to the negative electrode external terminal 13B. The upper end of the accommodation portion 11A is closed by the lid 12.

In step S3-4, the electrode body 20 is heated to remove moisture from the electrode body 20. Then, the non-aqueous electrolyte is injected into the case 11. The above described procedure manufactures the lithium-ion rechargeable battery 10.

Methods for Controlling BET Specific Surface Area

Methods for controlling the BET specific surface area of the negative electrode active material 26C in the negative electrode mixture layer 26 will now be described with reference to FIGS. 10 to 12. The BET specific surface area of the positive electrode active material in the positive electrode mixture layer 23 can be controlled in the same manner as the BET specific surface area of the negative electrode active material 26C in the negative electrode mixture layer 26. The manufacturing process changes the BET specific surface area of the negative electrode active material 26C in the negative electrode mixture layer 26 from the state of raw material.

BET Specific Surface Area of Raw Material

Point P1 shown in FIG. 10 represents the BET specific surface area of the negative electrode active material 26C in the state of raw material. The BET specific surface area of the negative electrode active material 26C in the state of raw material state has a positive correlation with the BET specific surface area of the negative electrode active material 26C included in the negative electrode mixture layer 26.

Therefore, for example, the negative electrode active material 26C used as the raw material of the second negative electrode mixture layer 26B may have a BET specific surface area that is greater than that of the negative electrode active material 26C used as the raw material of the first negative electrode mixture layer 26A. In this manner, the BET specific surface area of the negative electrode active material 26C in the second negative electrode mixture layer 26B becomes greater than that of the negative electrode active material 26C in the first negative electrode mixture layer 26A.

Solid Content Ratio during Dry-Kneading

Point P2 shown in FIG. 10 represents the BET specific surface area of the negative electrode active material 26C after the raw materials of the negative electrode mixture paste are dry-kneaded in step S1-2. When the raw materials are dry-kneaded in step S1-2, the negative electrode viscosity increasing agent (CMC) and the negative electrode binder 26D cover the surface of the negative electrode active material 26C and decrease the BET specific surface area of the negative electrode active material 26C.

In step S1-2, as the solid content ratio of the negative electrode mixture paste increases when dry-kneading raw materials, the raw materials will be rubbed against each other more strongly so that a greater amount of the negative electrode viscosity increasing agent and the negative electrode binder 26D adheres to the surface of the negative electrode active material 26C. In other words, as the solid content ratio of the negative electrode mixture paste increases when dry-kneading raw materials, the BET specific surface area of the negative electrode active material 26C is decreased by a greater amount by the dry-kneading.

Therefore, for example, the solid content ratio of the second negative electrode mixture paste when dry-kneading the second negative electrode mixture paste may be set lower than that of the first negative electrode mixture paste when dry-kneading the first negative electrode mixture paste. This reduces the surface area of the negative electrode active material 26C covered with the negative electrode binder 26D in the second negative electrode mixture layer 26B. In this manner, the BET specific surface area of the negative electrode active material 26C in the second negative electrode mixture layer 26B becomes greater than that of the negative electrode active material 26C in the first negative electrode mixture layer 26A.

Drying Condition

Point P3 shown in FIG. 10 represents the BET specific surface area of the negative electrode active material 26C after the negative electrode mixture paste is dried in step S2-2 or S2-5. When drying the negative electrode mixture paste, the heat causes a migration effect in which the negative electrode binder 26D in the negative electrode mixture paste is concentrated in the surface (side opposite to negative electrode substrate 25) of the negative electrode mixture paste. The speed of the migration of the negative electrode binder 26D has a positive correlation with the speed at which the negative electrode mixture paste is dried.

Charge-discharge reactions of the battery are likely to occur near the surface of the negative electrode mixture layer 26 as compared to inside the negative electrode mixture layer 26 (near negative electrode substrate 25). Thus, the migration of the negative electrode binder 26D further reduces the BET specific surface area of the negative electrode active material 26C near the surface of the negative electrode mixture layer 26.

As shown in FIG. 11, for example, when the second negative electrode mixture paste is dried at a speed that is lower than that of the first negative electrode mixture paste, the migration of the negative electrode binder 26D is relatively limited in the second negative electrode mixture layer 26B. This reduces the amount of the BET specific surface area of the negative electrode active material 26C decreased by the migration of the negative electrode binder 26D in the second negative electrode mixture layer 26B. In this manner, the BET specific surface area of the negative electrode active material 26C in the second negative electrode mixture layer 26B becomes greater than that of the negative electrode active material 26C in the first negative electrode mixture layer 26A.

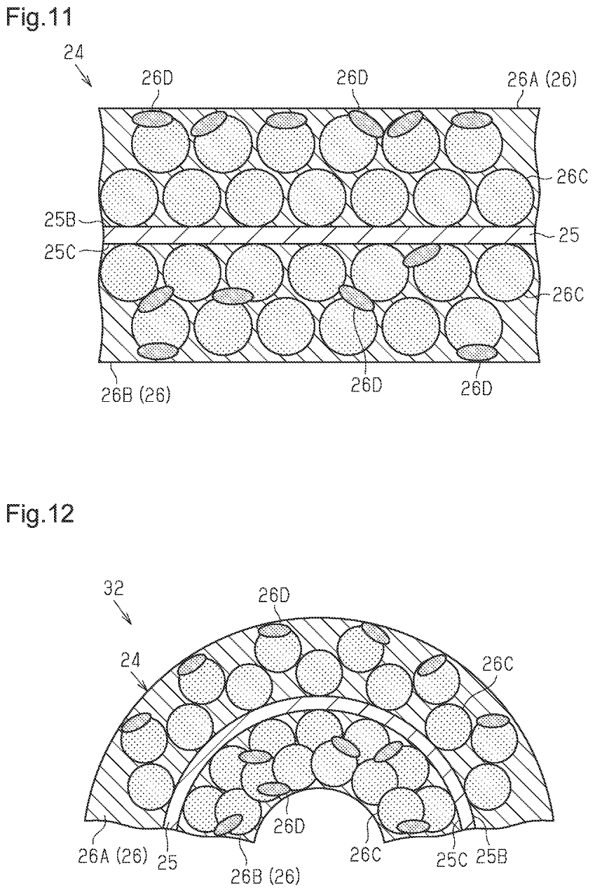

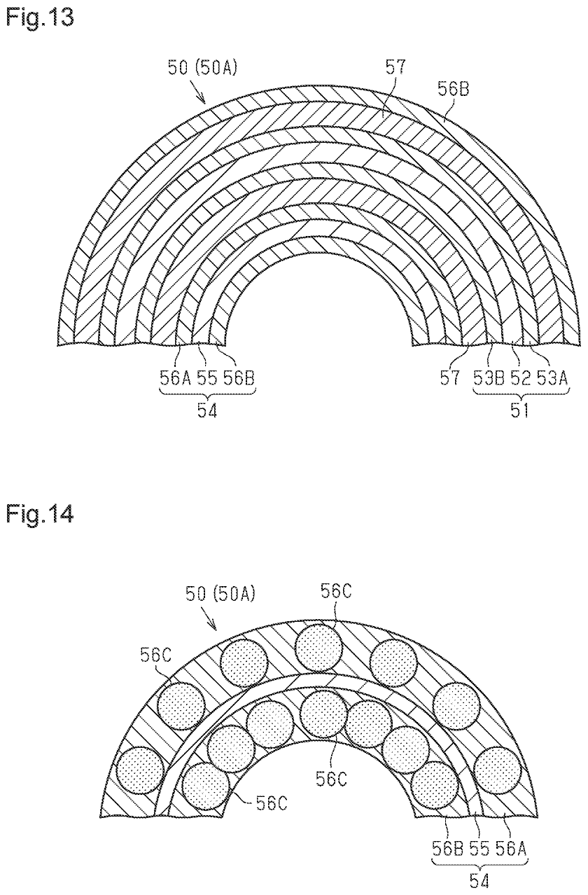

As shown in FIG. 12, at the upper curved portion 32 of the electrode body 20, which is formed by rolling the negative electrode plate 24 shown in FIG. 11, the density of the second negative electrode mixture layer 26B becomes higher than that of the first negative electrode mixture layer 26A, as described above. On the other hand, since the BET specific surface area of the negative electrode active material 26C in the second negative electrode mixture layer 26B is greater than that of the negative electrode active material 26C in the first negative electrode mixture layer 26A, the lithium deposition resistance becomes uniform between the first negative electrode mixture layer 26A and the second negative electrode mixture layer 26B at the upper curved portion 32.

As compared with step S2-2 in which only the first negative electrode mixture paste is applied to the negative electrode substrate 25, the second negative electrode mixture paste in step S2-5 dries at a speed that is lower by an amount corresponding to the thermal capacitance of the first negative electrode mixture layer 26A that has already been formed on the negative electrode substrate 25. In other words, the drying speed of the second negative electrode mixture paste can be decreased by simply performing the step of forming the second negative electrode mixture layer 26B after the step of forming the first negative electrode mixture layer 26A.

Pressing Condition

Referring back to FIG. 10, point P4 shown in FIG. 10 represents the BET specific surface area of the negative electrode active material 26C after the negative electrode mixture layer 26 is pressed in step S2-3 or step S2-6. When the negative electrode mixture layer 26 is pressed in step S2-3 or step S2-6, for example, the surface of the negative electrode active material 26C cracks and forms new surfaces, thereby increasing the BET specific surface area of the negative electrode active material 26C. In this case, as the pressed amount of the negative electrode mixture layer 26 increases, the BET specific surface area of the negative electrode active material 26C is increased by a greater amount.

Therefore, for example, the pressed amount of the second negative electrode mixture layer 26B may be set greater than that of the first negative electrode mixture layer 26A. In this manner, the BET specific surface area of the negative electrode active material 26C in the second negative electrode mixture layer 26B becomes greater than that of the negative electrode active material 26C in the first negative electrode mixture layer 26A.

In an example, the second negative electrode mixture paste may be applied such that the second negative electrode mixture paste has a weight per unit area that is greater than that of the first negative electrode mixture paste. In this manner, for example, when the value of the required thickness is the same for the first negative electrode mixture layer 26A and the second negative electrode mixture layer 26B, the pressed amount of the second negative electrode mixture layer 26B becomes greater than that of the first negative electrode mixture layer 26A by an amount corresponding to the difference in the weight per unit area between the first negative electrode mixture paste and the second negative electrode mixture paste.

In an example, the second negative electrode mixture paste may be diluted such that the diluted second negative electrode mixture paste has a solid content ratio that is greater than that of the diluted first negative electrode mixture paste in step S1-3. When the first negative electrode mixture paste and the second negative electrode mixture paste have the same weight per unit area, the second negative electrode mixture layer 26B that is not pressed is likely to be thicker due to the relatively high solid content ratio of the diluted second negative electrode mixture paste. In this manner, for example, when the value of the required thickness is the same for the first negative electrode mixture layer 26A and the second negative electrode mixture layer 26B, the pressed amount of the second negative electrode mixture layer 26B becomes greater than that of the first negative electrode mixture layer 26A by an amount corresponding to the difference in the thickness before the pressing between the first negative electrode mixture layer 26A and the second negative electrode mixture layer 26B.

In an example, the negative electrode active material 26C used as the raw material of the second negative electrode mixture layer 26B may have a tapped density that is less than that of the negative electrode active material 26C serving as the raw material of the first negative electrode mixture layer 26A. When the first negative electrode mixture paste and the second negative electrode mixture paste have the same weight per unit area, the second negative electrode mixture layer 26B that is not pressed is likely be thicker due to the relatively low tapped density of the negative electrode active material 26C. In this manner, for example, when the value of the required thickness is the same for the first negative electrode mixture layer 26A and the second negative electrode mixture layer 26B, the pressed amount of the second negative electrode mixture layer 26B becomes greater than that of the first negative electrode mixture layer 26A by an amount corresponding to the difference in the thickness before the pressing between the first negative electrode mixture layer 26A and the second negative electrode mixture layer 26B.

The BET specific surface area of the negative electrode active material 26C may be controlled by only one method or a combination of two or more methods. Further, the pressed amount of the second negative electrode mixture layer 26B may be set greater than that of the first negative electrode mixture layer 26A, in order to control the BET specific surface area of the negative electrode active material 26C, by only one of or a combination of two or more of the above-described methods for controlling the pressed amount.

### Advantages of the Embodiment

The above embodiment has the following advantages.

(1) The BET specific surface area of the negative electrode active material 26C in the second negative electrode mixture layer 26B is set to be greater than that of the negative electrode active material 26C in the first negative electrode mixture layer 26A. This reduces the resistance difference resulting from the density difference between the first negative electrode mixture layer 26A and the second negative electrode mixture layer 26B at the upper curved portion 32 and the lower curved portion 33. In this manner, the rate at which the first negative electrode mixture layer 26A accepts lithium ions and the rate at which the second negative electrode mixture layer 26B accepts lithium ions become uniform during charging. This uniformizes the lithium deposition resistance between the first negative electrode mixture layer 26A and the second negative electrode mixture layer 26B.

Further, when the BET specific surface area of the positive electrode active material in the second positive electrode mixture layer 23B is set to be greater than that of the positive electrode active material in the first positive electrode mixture layer 23A, the resistance difference resulting from the density difference can be reduced between the first positive electrode mixture layer 23A and the second positive electrode mixture layer 23B at the upper curved portion 32 and the lower curved portion 33. This uniformizes the rate at which the first positive electrode mixture layer 23A releases lithium ions and the rate at which the second positive electrode mixture layer 23B releases lithium ions during charging. Consequently, the lithium deposition resistance is uniformized between the second negative electrode mixture layer 26B, facing the first positive electrode mixture layer 23A, and the lithium deposition resistance in the first negative electrode mixture layer 26A, facing the second positive electrode mixture layer 23B.

(2) When the second negative electrode mixture paste is dried at a speed that is lower than that of the first negative electrode mixture paste, the migration of the negative electrode binder 26D is limited in the second negative electrode mixture layer 26B as compared to the first negative electrode mixture layer 26A. As a result, the BET specific surface area of the negative electrode active material 26C in the second negative electrode mixture layer 26B becomes greater than that of the negative electrode active material 26C in the first negative electrode mixture layer 26A. In this case, the same negative electrode mixture paste can be used as the first negative electrode mixture paste and the second negative electrode mixture paste. Thus, the manufacturing cost can be reduced. Further, when the second positive electrode mixture paste is dried at a speed that is lower than that of the first positive electrode mixture paste, the BET specific surface area of the positive electrode active material in the second positive electrode mixture layer 23B becomes greater than that of the positive electrode active material in the first positive electrode mixture layer 23A.

(3) When the step of forming the second negative electrode mixture layer 26B is performed after the step of forming the first negative electrode mixture layer 26A, the thermal capacitance when the second negative electrode mixture layer 26B is formed becomes greater by the amount corresponding to the first negative electrode mixture layer 26A that is already formed. Such a simple method can decrease the drying speed of the second negative electrode mixture paste to be lower than that of the first negative electrode mixture paste. Further, when the step of forming the second positive electrode mixture layer 23B is performed after the step of forming the first positive electrode mixture layer 23A, the drying speed of the second positive electrode mixture paste becomes lower than that of the first positive electrode mixture paste.

(4) When the negative electrode active material 26C used as the raw material of the second negative electrode mixture layer 26B has a BET specific surface area that is greater than that of the negative electrode active material 26C used as the raw material of the first negative electrode mixture layer 26A, the BET specific surface area of the negative electrode active material 26C in the second negative electrode mixture layer 26B becomes greater than that of the negative electrode active material 26C in the first negative electrode mixture layer 26A. Further, when the positive electrode active material, used as the raw material of the second positive electrode mixture layer 23B, has a BET specific surface area that is greater than that of the positive electrode active material, used as the raw material of the first positive electrode mixture layer 23A, the BET specific surface area of the positive electrode active material in the second positive electrode mixture layer 23B becomes greater than that of the positive electrode active material in the first positive electrode mixture layer 23A.

(5) When the solid content ratio of the second negative electrode mixture paste during dry-kneading of the second negative electrode mixture paste is set to be lower than that of the first negative electrode mixture paste during dry-kneading of the first negative electrode mixture paste, the BET specific surface area of the negative electrode active material 26C in the second negative electrode mixture layer 26B becomes greater than that of the negative electrode active material 26C in the first negative electrode mixture layer 26A. Further, when the solid content ratio of the second positive electrode mixture paste during dry-kneading of the second positive electrode mixture paste is set to be lower than that of the first positive electrode mixture paste during dry-kneading of the first positive electrode mixture paste, the BET specific surface area of the positive electrode active material in the second positive electrode mixture layer 23B becomes greater than that of the positive electrode active material in the first positive electrode mixture layer 23A.

(6) When the pressed amount of the second negative electrode mixture layer 26B is set to be greater than that of the first negative electrode mixture layer 26A, the BET specific surface area of the negative electrode active material 26C in the second negative electrode mixture layer 26B becomes greater than that of the negative electrode active material 26C in the first negative electrode mixture layer 26A. Further, when the pressed amount of the second positive electrode mixture layer 23B is set to be greater than that of the first positive electrode mixture layer 23A, the BET specific surface area of the positive electrode active material in the second positive electrode mixture layer 23B becomes greater than that of the positive electrode active material in the first positive electrode mixture layer 23A.

(7) When the second negative electrode mixture paste is applied such that the second negative electrode mixture paste has a weight per unit area that is greater than that of the first negative electrode mixture paste, the pressed amount of the second negative electrode mixture layer 26B becomes greater than that of the first negative electrode mixture layer 26A. In this case, the same negative electrode mixture paste can be used as the first negative electrode mixture paste and the second negative electrode mixture paste. Thus, the manufacturing cost can be reduced. Further, when the second positive electrode mixture paste is applied such that the second positive electrode mixture paste has a weight per unit area that is greater than that of the first positive electrode mixture paste, the pressed amount of the second positive electrode mixture layer 23B becomes greater than that of the first positive electrode mixture layer 23A.

(8) When the second negative electrode mixture paste is diluted such that the diluted second negative electrode mixture paste has a solid content ratio that is greater than that of the diluted first negative electrode mixture paste, the pressed amount of the second negative electrode mixture layer 26B becomes greater than that of the first negative electrode mixture layer 26A. Further, when the second positive electrode mixture paste is diluted such that the diluted second positive electrode mixture paste has a solid content ratio that is greater than that of the diluted first positive electrode mixture paste, the pressed amount of the second positive electrode mixture layer 23B becomes greater than that of the first positive electrode mixture layer 23A.

(9) When the negative electrode active material 26C, used as the raw material of the second negative electrode mixture layer 26B, has a tapped density that is lower than that of the negative electrode active material 26C, used as the raw material of the first negative electrode mixture layer 26A, the pressed amount of the second negative electrode mixture layer 26B becomes greater than that of the pressed amount of the first negative electrode mixture layer 26A. Further, when the positive electrode active material, used as the raw material of the second positive electrode mixture layer 23B, has a tapped density that is lower than that of the positive electrode active material, used as the raw material of the first positive electrode mixture layer 23A, the pressed amount of the second positive electrode mixture layer 23B becomes greater than that of the first positive electrode mixture layer 23A.

### Modified Examples

The above embodiment may be modified as described below. The following modifications can be combined as long as the combined modifications remain technically consistent.

The negative electrode active material 26C, used as the raw material of the second negative electrode mixture layer 26B, may have a tapped density that is greater than or the same as that of the negative electrode active material 26C, used as the raw material of the first negative electrode mixture layer 26A. In this case, a different method may be used to increase the BET specific surface area of the negative electrode active material 26C in the second negative electrode mixture layer 26B to be greater than that of the negative electrode active material 26C in the first negative electrode mixture layer 26A. Further, the positive electrode active material used as the raw material of the second positive electrode mixture layer 23B may have a tapped density that is greater than or the same as that of the positive electrode active material used as the raw material of the first positive electrode mixture layer 23A. In this case, a different method may be used to increase the BET specific surface area of the positive electrode active material in the second positive electrode mixture layer 23B to be greater than that of the positive electrode active material in the first positive electrode mixture layer 23A.

The solid content ratio of the diluted second negative electrode mixture paste may be less than or the same as that of the diluted first negative electrode mixture paste. In this case, a different method may be used to increase the BET specific surface area of the negative electrode active material 26C in the second negative electrode mixture layer 26B to be greater than that of the negative electrode active material 26C of the negative electrode active material 26C in the first negative electrode mixture layer 26A. Further, the solid content ratio of the diluted second positive electrode mixture paste may be less than or the same as that of the diluted first positive electrode mixture paste. In this case, a different method may be used to increase the BET specific surface area of the positive electrode active material in the second positive electrode mixture layer 23B to be greater than that of the positive electrode active material in the first positive electrode mixture layer 23A.

The weight per unit area of the second negative electrode mixture paste may be less than or the same as that of the first negative electrode mixture paste. In this case, a different method may be used to increase the BET specific surface area of the negative electrode active material 26C in the second negative electrode mixture layer 26B to be greater than that of the negative electrode active material 26C in the first negative electrode mixture layer 26A. Further, the weight per unit area of the second positive electrode mixture paste may be less than or the same as that of the first positive electrode mixture paste. In this case, a different method may be used to increase the BET specific surface area of the positive electrode active material in the second positive electrode mixture layer 23B to be greater than that of the positive electrode active material in the first positive electrode mixture layer 23A.

The pressed amount of the second negative electrode mixture layer 26B may be smaller than or the same as that of the first negative electrode mixture layer 26A. In this case, a different method may be used to increase the BET specific surface area of the negative electrode active material 26C in the second negative electrode mixture layer 26B to be greater than that of the negative electrode active material 26C in the first negative electrode mixture layer 26A. Further, the pressed amount of the second positive electrode mixture layer 23B may be smaller than or the same as that of the first positive electrode mixture layer 23A. In this case, a different method may be used to increase the BET specific surface area of the positive electrode active material in the second positive electrode mixture layer 23B to be greater than that of the positive electrode active material in the first positive electrode mixture layer 23A.

The solid content ratio of the second negative electrode mixture paste when dry-kneading the second negative electrode mixture paste may be greater than or the same as that of the first negative electrode mixture paste when dry-kneading the first negative electrode mixture paste. In this case, a different method may be used to increase the BET specific surface area of the negative electrode active material 26C in the second negative electrode mixture layer 26B to be greater than that of the negative electrode active material 26C in the first negative electrode mixture layer 26A. Further, the solid content ratio of the second positive electrode mixture paste when dry-kneading the second positive electrode mixture paste may be greater than or the same as that of the first positive electrode mixture paste when dry-kneading the first positive electrode mixture paste. In this case, a different method may be used to increase the BET specific surface area of the positive electrode active material in the second positive electrode mixture layer 23B to be greater than that of the positive electrode active material in the first positive electrode mixture layer 23A.

The negative electrode active material 26C used as the raw material of the second negative electrode mixture layer 26B may have a BET specific surface area that is less than or the same as that of the negative electrode active material 26C used as the raw material of the first negative electrode mixture layer 26A. In this case, a different method may be used to increase the BET specific surface area of the negative electrode active material 26C in the second negative electrode mixture layer 26B to be greater than that of the negative electrode active material 26C in the first negative electrode mixture layer 26A. Further, the positive electrode active material used as the raw material of the second positive electrode mixture layer 23B may have a BET specific surface area that is less than or the same as that of the positive electrode active material used as the raw material of the first positive electrode mixture layer 23A. In this case, a different method may be used to increase the BET specific surface area of the positive electrode active material in the second positive electrode mixture layer 23B to be greater than that of the positive electrode active material in the first positive electrode mixture layer 23A.

The step of forming the first negative electrode mixture layer 26A may be performed after the step of forming the second negative electrode mixture layer 26B. In this case, for example, the second negative electrode mixture paste may be dried at a speed that is lower than that of the first negative electrode mixture paste by changing drying conditions such as air volume, temperature, and the like. Further, the step of forming the first positive electrode mixture layer 23A may be performed after the step of forming the second positive electrode mixture layer 23B. In this case, for example, the second positive electrode mixture paste may be dried at a speed that is lower than that of the first positive electrode mixture paste by changing drying conditions such as air volume, temperature, and the like.

The drying speed of the second negative electrode mixture paste may be higher than or the same as that of the first negative electrode mixture paste. In this case, a different method may be used to increase the BET specific surface area of the negative electrode active material 26C in the second negative electrode mixture layer 26B to be greater than that of the negative electrode active material 26C in the first negative electrode mixture layer 26A. Further, the drying speed of the second positive electrode mixture paste may be higher than or the same as that of the first positive electrode mixture paste. In this case, a different method may be used to increase the BET specific surface area of the positive electrode active material in the second positive electrode mixture layer 23B to be greater than that of the positive electrode active material in the first positive electrode mixture layer 23A.

As long as the BET specific surface area of the positive electrode active material in the second positive electrode mixture layer 23B is greater than that of the positive electrode active material in the first positive electrode mixture layer 23A, the BET specific surface area of the negative electrode active material 26C in the second negative electrode mixture layer 26B may be less than or the same as that in the first negative electrode mixture layer 26A. Further, as long as the BET specific surface area of the negative electrode active material 26C in the second negative electrode mixture layer 26B is greater than that of the negative electrode active material 26C in the first negative electrode mixture layer 26A, the BET specific surface area of the positive electrode active material in the second positive electrode mixture layer 23B may be less than or the same as that in the first positive electrode mixture layer 23A. Furthermore, the BET specific surface area of the positive electrode active material in the second positive electrode mixture layer 23B may be greater than that of the positive electrode active material in the first positive electrode mixture layer 23A, and the BET specific surface area of the negative electrode active material 26C in the second negative electrode mixture layer 26B may be greater than that of the negative electrode active material 26C in the first negative electrode mixture layer 26A. In this case, the first negative electrode mixture layer 26A and the second negative electrode mixture layer 26B accept lithium ions at a uniform rate, and the first positive electrode mixture layer 23A and the second positive electrode mixture layer 23B release lithium ions at a uniform rete during charging. This further uniformizes the lithium deposition resistance in the negative electrode mixture layer 26.

The lithium-ion rechargeable battery 10 may be another type of non-aqueous rechargeable battery, and may be, for example, a nickel-metal hydride battery.

The lithium-ion rechargeable battery 10 may be used in an automatic transporting vehicle, a special hauling vehicle, a battery electric vehicle, a hybrid electric vehicle, a computer, an electronic device, or any other system. For example, the lithium-ion rechargeable battery 10 may be used in a marine vessel, an aircraft, or any other type of movable body. The lithium-ion rechargeable battery 10 may also be used in a system that supplies electric power from a power plant via a substation to buildings and households.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A non-aqueous rechargeable battery, comprising:
an electrode body formed by rolling a stack of a positive electrode plate and a negative electrode plate with a separator arranged in between, wherein:
at least one of the positive electrode plate and the negative electrode plate includes
a substrate,
a first mixture layer located on an outer side of the substrate, and
a second mixture layer located on an inner side of the substrate; and
the second mixture layer includes an active material having a BET specific surface area that is greater than that of an active material included in the first mixture layer.

2. The non-aqueous rechargeable battery according to claim 1, wherein
the electrode body includes a curved portion in which layers of the electrode body are curved, and
the second mixture layer has a density at the curved portion that is greater than that of the first mixture layer at the curved portion.

3. A method for manufacturing a non-aqueous rechargeable battery, the method comprising:
manufacturing a positive electrode plate;
manufacturing a negative electrode plate; and
manufacturing an electrode body by rolling a stack of the positive electrode plate and the negative electrode plate with a separator arranged in between, wherein:
at least one of the manufacturing the positive electrode plate and the manufacturing the negative electrode plate includes
forming a first mixture layer on a first surface of a substrate, and
forming a second mixture layer on a second surface of the substrate opposite to the first surface;
the forming the second mixture layer on the second surface is performed such that the second mixture layer includes an active material having a BET specific surface area that is greater than that of an active material included in the first mixture layer; and
the manufacturing the electrode body includes rolling the substrate such that the first mixture layer is located on an outer side of the substrate and the second mixture layer is located on an inner side of the substrate.

4. The method according to claim 3, wherein:
the forming the first mixture layer includes
applying a first mixture paste to the first surface, and
drying the first mixture paste;
the forming the second mixture layer includes
applying a second mixture paste to the second surface, and
drying the second mixture paste; and
the second mixture paste is dried at a speed that is lower than that of the first mixture paste.

5. The method according to claim 4, wherein the forming the second mixture layer is performed after the forming the first mixture layer.

6. The method according to claim 3, wherein an active material used as a raw material of the second mixture layer has a BET specific surface area that is greater than that of an active material used as a raw material of the first mixture layer.

7. The method according to claim 3, wherein:
the forming the first mixture layer includes
dry-kneading a first mixture paste including a raw material of the first mixture layer, and
diluting the dry-kneaded first mixture paste;
the forming the second mixture layer includes
dry-kneading a second mixture paste including a raw material of the second mixture layer, and
diluting the dry-kneaded second mixture paste; and
the second mixture paste that is dry-kneaded has a solid content ratio that is lower than that of the first mixture paste that is dry-kneaded.

8. The method according to claim 3, wherein
the forming the first mixture layer includes pressing the first mixture layer to adjust a thickness of the first mixture layer,
the forming the second mixture layer includes pressing the second mixture layer to adjust a thickness of the second mixture layer, and
a pressed amount of the second mixture layer is greater than that of the first mixture layer.

9. The method according to claim 8, wherein:
the forming the first mixture layer further includes
applying a first mixture paste including a raw material of the first mixture layer to the first surface, and
drying the first mixture paste;
the forming the second mixture layer further includes
applying a second mixture paste including a raw material of the second mixture layer to the second surface, and
drying the second mixture paste; and
the applying a second mixture paste is performed such that the second mixture paste has a weight per unit area that is greater than that of the first mixture paste.

10. The method according to claim 8, wherein:
the forming the first mixture layer further includes
dry-kneading a first mixture paste including a raw material of the first mixture layer,
diluting the dry-kneaded first mixture paste,
applying the diluted first mixture paste to the first surface, and
drying the first mixture paste;
the forming the second mixture layer further includes
dry-kneading a second mixture paste including a raw material of the second mixture layer,
diluting the dry-kneaded second mixture paste,
applying the diluted second mixture paste to the second surface, and
drying the second mixture paste; and
the diluting the dry-kneaded second mixture paste is performed such that the diluted second mixture paste has a solid content ratio that is greater than that of the diluted first mixture paste.

11. The method according to claim 8, wherein an active material used as a raw material of the second mixture layer has a tapped density that is less than that of an active material used as a raw material of the first mixture layer.
